(19) United States
(12) Patent Application Publication
(10) Pub. No.: US 2003/0002560 A1
(43) Pub. Date: Jan. 2, 2003

(54) Dipping type optical fiber radiation thermometer for molten metal thermometry and thermometry method for molten metal

(76) Inventors: Zenkichi Yamanaka, Kawasaki-shi (JP); Yoshiaki Narishige, Kitakyushu-shi (JP); Kazuhiro Oe, Kitakyushu-shi (JP); Kazuo Nomura, Kitakyushu-shi (JP)

Correspondence Address: FRISHAUF, HOLTZ, GOODMAN & CHICK, PC, 767 THIRD AVENUE, 25TH FLOOR, NEW YORK, NY, 10017-2023, US

(21) Appl. No.: 10/181,180

(22) PCT Filed: Oct. 31, 2001
(86) PCT No.: PCT/JP01/09537

(30) Foreign Application Priority Data
Oct. 31, 2000 (JP) 2000-332334

(51) Int. Cl. G01K 1/12

(52) U.S. Cl. 374/139; 374/121; 374/130

(57) ABSTRACT

Dipping type optical fiber radiation thermometer for measuring temperature of molten metal, which comprises:

a metal pipe covered optical fiber comprising an optical fiber core wire which condenses light at the front end thereof and guides the condensed light therethrough to the back end thereof, and a metal pipe made of a heat resisting nickel-based alloy which covers and protects the optical fiber core wire, and a thermo-metering means connected with the rear end of optical fiber core wire, and calculating a temperature value in proportion to the radiant energy of the light guided thereto; wherein the metal pipe covered optical fiber penetrates the wall of a container for molten metal, and the front end of the metal pipe covered optical fiber is positioned to be almost or just flush with the inner surface of the container or to protrude through the inner surface of the container with a predetermined length; and

thermometry method for the molten metal using the dipping type optical fiber radiation thermometer: which comprises measuring temperature of molten metal retained in the container by a separate thermo-metering means, and correcting the temperature value calculated in proportion to the radiant energy of the light determined by the thermo-metering means of the dipping type optical fiber radiation thermometer, on the basis of the thermometry result obtained at the separate thermo-metering means.

### TECHNICAL FIELD

This invention relates to a thermometry instrument for molten metal, particularly, a dipping type optical fiber radiation thermometer for continuously measuring of the temperature of molten metal in the container, such as smelting furnace, etc., by use of the radiation energy, and a method of measuring the temperature of molten metal using thereof.

### BACKGROUND ART

FIG. 4 is a block diagram which shows the construction of the molten steel thermometry system in the steel converter according to the molten metal thermometry method and instrument of JP-A-7-140007. In FIG. 4, molten metal 11 is put in the molten metal container 10, and a nozzle 12 is provided at the sidewall portion of the molten metal container 10, which pierced through the wall of the container 10. Through this nozzle 12, a guide pipe 13 is inserted. Further, through this guide pipe 13, a metal coated optical fiber 15 which is sent out from optical fiber feeding device 14 is inserted. Additionally, purge gas is blown through this guide pipe 13 into the container.

The optical fiber feeding device 14 comprises an optical fiber drum 16 where the metal coated optical fiber 15 is wound around, and a roll mechanism 19 for sending out the metal coated optical fiber 15. Via guide pipe 12, one edge of metal coated fiber 15 is introduced into the molten metal stored in the molten metal container 10. The other edge is connected to an infrared radiation thermometer 18.

A dipping type thermocouple 20 is immersed in the molten metal 11, and it is connected to a thermocouple temperature converter 21, thus, the temperature of molten metal 11 is measured. Then, based on the measured temperature value, the error due to the decrease in the length of metal pipe covered optical fiber is compensated for, and the change of the sensitivity behavior is proofreaded properly. Therefore, defects of the consumable dipping type thermocouple which is dipped in the molten steel, or defects of the radiation thermometer which is used to determine the temperature of molten steel surface are solved, and the molten steel temperature may be continuously and accurately measured.

However, by using the above mentioned prior art, the following problems may be taken place, when thermometry is practiced continuously with respect to the molten steel in the fusion furnace where the furnace body is subjected to reverse or oscillation.

(1) It comes to be impossible to determine the temperature, except to feed the metal coated fiber into the molten steel continuously, since the metal coated fiber is consumed in the molten steel along the time course.

(2) Further, it must be equipped with some additional devices, such as the optical fiber feeding device and the optical fiber drum where the metal coated optical fiber 15 is wound around, and thus, installation site for the instrument is restricted.

(3) Especially, when the instrument is installed on the sidewall of the fusion furnace by reason of difficulty of setting it on the external surface at the bottom of fusion furnace, it is impossible to determine the temperature upon phases of putting the fusion furnace into its reverse position or into oscillation, since the measuring part is located over the surface of molten metal upon such phases, thus the continuous temperature measuring will end in failure.

(4) Since the raw material to be charged into the furnace usually is unfused one, the thermocouple protecting tube tends to be damaged with facility by the mechanical collision with the charge, the life of the thermocouple protecting tube falls short of the furnace's life, and it is difficult for the instrument to be subjected to the repeating and continuous temperature measurement over several charges.

### DISCLOSURE OF INVENTION

The present invention was made in order to solve the aforesaid problem, and aims to provide a dipping type optical fiber radiation thermometer for molten metal thermometry, capable of measuring continuously the temperature of molten metal retained in a container such as fusion furnace during a necessitated period, and provide a thermometry method for molten metal in an analogous fashion.

According to one of the features of the present invention, a dipping type optical fiber radiation thermometer for measuring temperature of molten metal is provided, which comprises as follows:

a metal pipe covered optical fiber comprising an optical fiber core wire which condenses light at the front end thereof and guides the condensed light therethrough to the back end thereof, and a metal pipe made of a heat resisting nickel-based alloy which covers and protects the optical fiber core wire; and

a thermo-metering means connected with the rear end of optical fiber core wire, and calculating a temperature value in proportion to the radiant energy of the light guided thereto;

wherein the metal pipe covered optical fiber penetrates the wall of a container for molten metal, and the front end of the metal pipe covered optical fiber is positioned so as to be almost or just flush with the inner surface of the container or to protrude through the inner surface of the container with a predetermined length.

Further, a dimple is prepared on the inner surface of the container in order to embrace the front end of the metal pipe covered optical fiber therein.

Further more, the thermo-metering means is located on the outer surface of the container, or on a support frame for the container.

According to another feature of the present invention, a thermometry method for the molten metal using a dipping type optical fiber radiation thermometer is provided, which comprises the following steps:

on a thermometry method for the molten metal using a dipping type optical fiber radiation thermometer comprising

a metal pipe covered optical fiber comprising an optical fiber core wire which condenses light at the front end thereof and guides the condensed light therethrough to the back end thereof, and a metal pipe made of a heat resisting nickel-based alloy which covers and protects the optical fiber core wire, and

a thermo-metering means connected with the rear end of optical fiber core wire, and calculating a temperature value in proportion to the radiant energy of the light guided thereto;

wherein the metal pipe covered optical fiber penetrates the wall of a container for molten metal, and the front end of the metal pipe covered optical fiber is positioned so as to be almost or just flush with the inner surface of the container or to protrude through the inner surface of the container with a predetermined length;

measuring temperature of molten metal retained in the container by a separate thermo-metering means, and

correcting the temperature value calculated in proportion to the radiant energy of the light determined by the thermo-metering means of the dipping type optical fiber radiation thermometer, on the basis of the thermometry result obtained at the separate thermo-metering means.

Further, a dimple is prepared on the inner surface of the container in order to embrace the front end of the metal pipe covered optical fiber therein.

Further more, the thermo-metering means used is located on the outer surface of the container, or on a support frame for the container.

### BRIEF DESCRIPTION OF DRAWINGS

FIG. 1 is a longitudinal sectional view which explains a construction of one embodiment of the dipping type optical fiber radiation thermometer according to this invention;

FIG. 2 is a longitudinal sectional view which explains a construction of another embodiment of the dipping type optical fiber radiation thermometer according to this invention;

FIG. 3 is a longitudinal sectional view which explains a construction of further separate embodiment of the dipping type optical fiber radiation thermometer according to this invention; and

FIG. 4 is a block diagram which shows the construction of the molten steel thermometry system in the steel converter according to the prior art of molten metal thermometry method and instrument.

### BEST MODE FOR CARRYING OUT THE INVENTION

First Embodiment

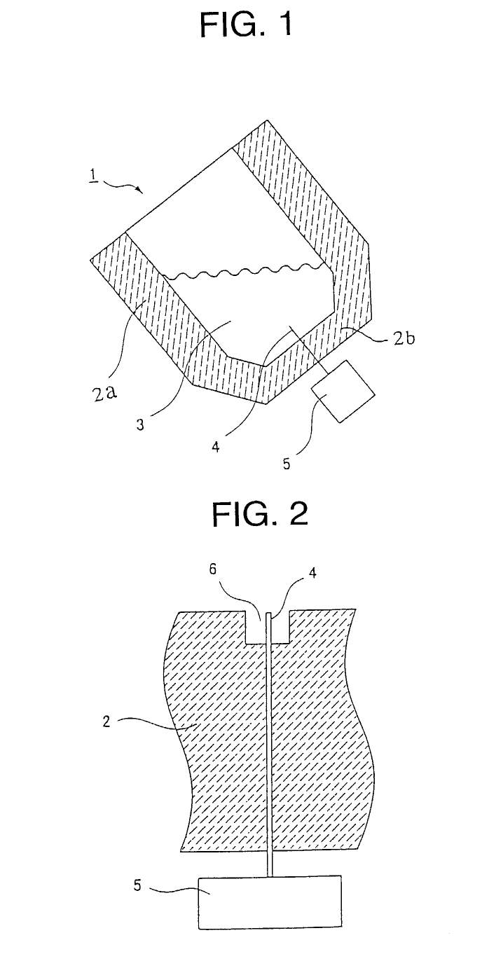

FIG. 1 is a longitudinal sectional view which explains a construction of one embodiment of the dipping type optical fiber radiation thermometer according to this invention. In FIG. 1, the numeral 1 denotes a fusion furnace comprising a furnace wall (2a) and a furnace bottom (2b), each made of refractories. Dipping type optical fiber radiation thermometer of the present invention has a metal pipe covered optical fiber 4 which condenses light at the front end thereof, the metal pipe being made of a heat resisting nickel-based alloy, and a thermo-metering means 5 which is connected with the rear end of metal pipe covered optical fiber 4, and calculates a temperature value in proportion to the radiant energy of the light guided thereto.

At the furnace bottom (2b), the metal pipe covered optical fiber 4 is positioned by penetrating the wall of the bottom, and the front end of the metal pipe covered optical fiber 4 protrudes through the inner surface of the container with a length of 0-5 mm. The rear end of the metal pipe covered optical fiber 4 is connected to the thermo-metering means 5 via an optical connector, and the thermo-metering means 5 is attached to the furnace body with an intervening thermal insulation means.

For example, as a optical fiber core wire of the metal pipe covered optical fiber 4, PI covered GI optical fiber having the outer diameter of about 0.25 mm may be used, and as a metal pipe for covering and protecting the optical fiber, Ni based heat-resisting alloy (Inconel) having the outer diameter of about 1.6 mm maybe used. However, they are not limited thereto, and the size and alloy type there of maybe chosen anyway properly.

Therefore, the optical fiber feeding device, etc. are not necessitated for the instrument, because the metal pipe of Ni based heat-resisting alloy (Inconel) for the covering and protecting the optical fiber is hard to affect in molten steel, and this fact protects the optical fiber core wire from the molten steel. Therefore, the dipping type optical fiber radiation thermometer can be a simple construction, and it gives the dipping type optical fiber radiation thermometer to position in the blast furnace bottom. There is no equipment which is influenced by tilting or oscillation of the furnace-body. Thus, even when the furnace-body is in tilting or oscillating, the temperature measuring point can be set under the surface of the molten metal and the temperature measuring can be done in real-time continuously through all time.

Second Embodiment

FIG. 2 is a longitudinal sectional view which explains a construction of another embodiment of the dipping type optical fiber radiation thermometer according to this invention.

In the embodiment shown FIG. 2, the basal configuration of the thermometer is similar with that of the embodiment shown in FIG. 1. Thus, the explanation for common parts and members are omitted. In the embodiment shown FIG. 2, however, as differ from the first embodiment, a depression part 6 (for example, about 25 mm in diameter, about 25 mm in depth) is prepared at a site of furnace bottom 2, and the front end of the metal pipe covered optical fiber 4 is stored within the dimple (depression part) 6 therein. Therefore, any damage is not given to the metal pipe covered optical fiber 4, when the solid raw material is put into the inside of furnace-body 1. Because, the front end of the metal pipe covered optical fiber 4 does not protrude from the face of the furnace bottom 2. Incidentally, size and shape of depression part 6 can be selected appropriately.

Third Embodiment

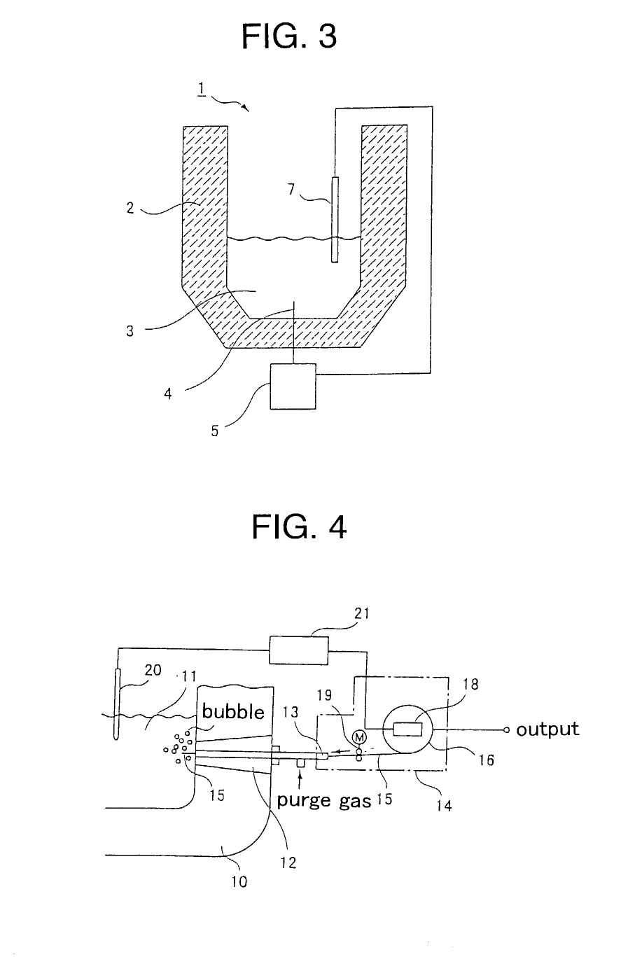

FIG. 3 is a longitudinal sectional view which explains a construction of further separate embodiment of the dipping type optical fiber radiation thermometer according to this invention. Parts and members in FIG. 3 are similar with those shown in FIG. 1. Thus, the explanation for common parts and members are omitted. In the embodiment shown FIG. 3, however, as differ from the first embodiment, another dipping type thermocouple 7, as a separate thermo-metering means, is inserted into the molten steel 3 from the upper side of furnace-body. This dipping type thermocouple 7 can be placed freely upwardly and downwardly or moved to withdrawal by a not-shown supporting means. By using this dipping type thermocouple 7, the temperature of molten steel 3 is measured as one-shot operation or intermittent operation. Then, the temperature value calculated in proportion to the radiant energy of the light determined by the thermo-metering means of the dipping type optical fiber radiation thermometer is corrected, on the basis of the thermometry result obtained by the thermocouple. In order to attain this operation, the value of molten steel temperature determined by the dipping type thermocouple 7 is input to the thermo-metering means 5, and herein the correction is done.

Therefore, the temperature measuring accuracy does not lower during a long-time and continuous use, even if the translucent property of the front end of the optical fiber of the dipping type optical fiber radiation thermometer may be varied due to the use in a long-time, since this variation can be corrected. Incidentally, as the separate temperature measuring means, it is not limited to the aforesaid dipping type thermocouple, and it may be a consumable optical fiber radiation thermometer, a furnace wall embedded type sensor, or the like.

In addition, although the aforesaid embodiments are described with respect to the molten steel, the present invention is not limited there to, and the present invention can be practiced to anyway of cast iron, copper, copper alloy, aluminum, aluminum alloy, etc., as the molten metal.

According to the dipping type optical fiber radiation thermometer of the present invention as described above, the remarkable effects as follows are obtained:

(1) According to the invention claimed in claim 1, the optical fiber is appropriately protected, because the covering and protecting metal pipe formed by Ni based heat-resisting alloy is hard to melt and to have damages in molten steel. Therefore, it is possible to determine the temperature of molten metal without feeding continuously the optical fiber into the molten metal. Thus, no feeding device for continuously feeding the optical fiber into the molten metal is necessitated. Then, the instrument can be a simple construction, and it gives the dipping type optical fiber radiation thermometer to position in the blast furnace bottom. As a result, even when the furnace-body is in tilting or oscillating, the temperature measuring can be done in real-time continuously through all time.

(2) According to the invention claimed in claim 2, it is possible to measure the temperature over several charges without replacement, because a depression part is prepared at a site of furnace bottom in order to be capable of embracing the front end of the metal pipe covered optical fiber therein, and thus any damage are not given to the metal pipe covered optical fiber on the charging of the solid raw material into the inside of furnace-body.

(3) According to the invention claimed in claim 4, the temperature measuring accuracy does not lower during a long-time and continuous use, because the temperature is measured as one-shot operation or intermittent operation by using the dipping type thermocouple or the like, and then the temperature value calculated in proportion to the radiant energy of the light determined by the thermo-metering means of the dipping type optical fiber radiation thermometer is corrected, on the basis of the thermometry result obtained by the thermocouple.

Since continued thermo-metering for the molten metal can be realized as described above, it is possible to monitor the temperature of molten bath continuously through a series of steps comprising charging of the raw material, collapse of the raw material by melting, beginning of melting, and completing of tapping. Therefore, it becomes possible to control the thermal capacity properly in accordance to the situation, and to heighten the manufacturing efficiency and to reduce the use energy.

1. Dipping type optical fiber radiation thermometer for measuring temperature of molten metal,
which comprises:
a metal pipe covered optical fiber comprising an optical fiber core wire which condenses light at the front end thereof and guides the condensed light therethrough to the back end thereof, and a metal pipe made of a heat resisting nickel-based alloy which covers and protects the optical fiber core wire; and
a thermo-metering means connected with the rear end of optical fiber core wire, and calculating a temperature value in proportion to the radiant energy of the light guided thereto;
wherein the metal pipe covered optical fiber penetrates the wall of a container for molten metal, and the front end of the metal pipe covered optical fiber is positioned to be almost or just flush with the inner surface of the container or to protrude through the inner surface of the container with a predetermined length.

2. Dipping type optical fiber radiation thermometer for measuring temperature of molten metal according to claim 1,
wherein a dimple is formed on the inner surface of the container in order to embrace the front end of the metal pipe covered optical fiber therein.

3. Dipping type optical fiber radiation thermometer for measuring temperature of molten metal according to claim 1 or claim 2,
wherein the thermo-metering means is located on the outer surface of the container, or on a support frame for the container.

4. Thermometry method for the molten metal using a dipping type optical fiber radiation thermometer:
which dipping type optical fiber radiation thermometer comprises
a metal pipe covered optical fiber comprising an optical fiber core wire which condenses light at the front end thereof and guides the condensed light therethrough to the back end thereof, and a metal pipe made of a heat resisting nickel-based alloy which covers and protects the optical fiber core wire, and
a thermo-metering means connected with the rear end of optical fiber core wire, and calculating a temperature value in proportion to the radiant energy of the light guided thereto;
wherein the metal pipe covered optical fiber penetrates the wall of a container for molten metal, and the front end of the metal pipe covered optical fiber is positioned to be almost or just flush with the inner surface of the container or to protrude through the inner surface of the container with a predetermined length; and
which method comprises
measuring temperature of molten metal retained in the container by a separate thermo-metering means, and
correcting the temperature value calculated in proportion to the radiant energy of the light determined by the thermo-metering means of the dipping type optical fiber radiation thermometer, on the basis of the thermometry result obtained at the separate thermo-metering means.

5. Thermometry method for the molten metal according to claim 4, where in a dimple is formed on the inner surface of the container in order to embrace the front end of the metal pipe covered optical fiber therein.

6. Thermometry method for the molten metal according to claim 4 or claim 5, wherein the thermo-metering means of the dipping type optical fiber radiation thermometer used is located on the outer surface of the container, or on a support frame for the container.
